(19) United States
(12) Patent Application Publication
(10) Pub. No.: US 2011/0095443 A1
(43) Pub. Date: Apr. 28, 2011

(54) Method for Producing an Optical Fiber Strip Comprising Several Inidividual Optical Fibers

(75) Inventors: Martin Franke, Berlin (DE); Tobias Happel, Berlin (DE); Mathias Miedreich, Neumarkt (DE); Helmut Nowsch, Regensburg (DE)

(73) Assignee: SIEMENS AKTIENGESELLSCHAFT, Muenchen (DE)

(21) Appl. No.: 11/922,315

(22) PCT Filed: May 31, 2006
(86) PCT No.: PCT/EP2006/062762

§ 371 Date: Sep. 28, 2009

(30) Foreign Application Priority Data
Jun. 15, 2005 (DE) 10 2005 028 659.3

(51) Int. Cl. G02B 6/04; G02B 6/44

(52) U.S. Cl. 264/1.28

(57) ABSTRACT

The invention relates to a method for creating a fibre strip (12) composed of individual fibres (11). some sections of the latter (11) being subjected to a surface treatment, far example by moms of a laser (13). According to the invention, the individual fibres (11) are conducted in the fibre strip (12) without torsion, at least between the treatment process step and the fitting process step to prevent distortion. This ensures that the angular position of the surface-treated sections in the fibre strip (12) can be advantageously predicted and that the optical behaviour of the fibre strip, which is dependent on the flexure, permits conclusions to be drawn about the degree of bonding in the fibre strip. The fibre strip can be used, for example, as a sensor strip, which can be utilised in the bumper of a motor vehicle to identify the impact of pedestrians.

### CROSS REFERENCE TO RELATED APPLICATIONS

This application is based on and hereby claims priority to German Application No. 10 2005 028 659.3 filed on Jun. 15, 2005, the contents of which are hereby incorporated by reference.

### BACKGROUND

Described below is a method for producing an optical fiber strip having a plurality of parallel-running individual optical fibers, in which the surface of the individual fibers is treated in places such that the bending dependency of the optical attenuation increases in the treated sections.

One method such as this is disclosed, for example, in U.S. Pat. No. 5,321,257. According to this method, the bending dependency of the optical attenuation of individual fibers can be increased by structuring the surface of the individual fibers in places by a hot stamping tool. The surface structure increases the overall attenuation of the individual fibers, of course, irrespective of the bending. However, since this surface structuring is carried out only at one point on the circumference of the optical waveguide, the degree of attenuation in that section is at the same time dependent on the bending of the individual optical fibers. Specifically, if the structured area is located on the concave side of the bent individual fibers, then the optical attenuation is decreased. However, the bending increases the attenuation in the convex area of the bend. The bending state can therefore be deduced by determining the attenuation of the individual fibers.

In addition, a plurality of individual fibers can be joined together to form a fiber strip, in which case, according to U.S. Pat. No. 5,321,257, the individual optical fibers are joined together such that this in each case results in an angular offset of the surface-structured areas with respect to the circumference of the individual optical fibers. Any three-dimensional deformation of the fiber strip in space can therefore also be determined using the fiber strip produced in this way.

### SUMMARY

Described below is a method for producing an optical fiber strip having a plurality of individual optical fibers which are treated in places, which strip allows comparatively good reproducibility to be achieved for the required optical behavior of the fiber strip.

The fiber strip is produced continuously, with the individual fibers being guided without torsion at least between the surface treatment and a subsequent joining together of the individual fibers to produce the fiber strip. The torsion-free guidance ensures that twisting of the angular position of the treated section is not changed when this section is between the surface treatment and the subsequent joining of the individual fibers together. This makes it possible to join the individual fibers to one another with the surface-treated sections in a predeterminable angular position, thus also making it possible to accurately predict the bending dependency of the optical behavior of the fiber strip. This advantageously makes it possible to use the fiber strips that are produced as, for example, sensor strips with optical characteristics which can be predicted accurately.

According to one advantageous refinement of the method, the individual fibers are deflected during the torsion-free guidance by bending the individual fibers. The need to deflect the individual fibers because of the process requirements advantageously nevertheless allows torsion-free guidance since the introduction of a bending load into the individual optical fibers does not produce any torsional stresses in the individual fibers, thus ensuring that the individual fibers are guided without torsion. If the spatial requirements of the process require that the individual optical fibers be guided in such a way that it is not possible to guide the respective individual fibers on one plane, then the guidance can be achieved by bending the individual fibers successively on two different planes.

One particular refinement of the method provides for the individual fibers to be bent by deflection rollers over which the individual fibers are passed. The use of deflection rollers has the advantage that this allows the individual fibers to be bent with a constant bending radius particularly easily. The diameter of the deflection roller at the same time ensures that the bending radius of the individual fibers cannot be less than a specific radius, thus at the same time ensuring protection against excessive bending.

Additional protection against twisting of the individual fibers is advantageously achieved by profiling the circumference of at least one deflection roller such that the contact area of the individual fibers guided on the deflection roller is enlarged. This means that the profile on the circumference of the deflection roller is matched to the cross section of the individual fibers to be guided, that is to say, so to speak, maps the negative form of the cross section. Additionally, for example, the profile on the circumference of the deflection rollers can be rubberized in order to produce a surface characteristic which additionally makes it harder for the individual fibers to slide.

It is also advantageous for the rotation axes of the deflection rollers to be aligned at least essentially parallel to one another. This allows the individual optical fibers to be guided essentially on one plane, thus further reducing the risk of twisting of the individual fibers.

The effectiveness of the production process can advantageously be improved further by the individual fibers being unwound from supply reels and then being supplied to the production process. This advantageously allows the process to be carried out continuously over a long time period. The supply reel also allows the individual fibers to be stored largely without any torsion before their processing, so that they can be supplied to the production process without any intrinsic stress.

It is particularly advantageous for the rotation axes of the supply reels also to be at least essentially parallel to the rotation axes of the deflection rollers. This makes it possible to eliminate further sources for possible torsion loading of the individual fibers.

A further improvement in the efficiency of the manufacturing process can advantageously be achieved by the fiber strip being wound up onto a cable drum. This makes it possible to make use of a reel-to-reel process.

In order to produce a stable fiber strip as the end product, in which the individual fibers are protected against torsion during use of the fiber strip as well, it is advantageous for the fiber strip to be produced, once the individual fibers have been joined together, by extrusion coating the individual fibers with a casing material. In addition to providing protection against twisting of the fiber strips with respect to one another, the casing material also advantageously provides protection against damage to the surface of the individual fibers. This ensures reliable use during operation of the fiber strip, since damage to the surface of the individual fibers would lead to corruption of the attenuation characteristics.

In addition, it is advantageous for the individual fibers to be guided without torsion during the extrusion coating process and subsequent curing of the casing material. This is because, until the casing material has cured, there is still a risk of torsion of the individual fibers, which would lead to a deterioration in the quality of the strip that is produced. Torsion of the individual fibers during the curing process can be effectively prevented by torsion-free guidance, on the basis of the already explained circumstances. The process of curing the casing material should be understood in the wider sense as meaning any form of solidification of the casing material after extrusion coating. For example, if a suitable plastic is chosen curing may be carried out by UV light irradiation. If thermoplastics are used as the casing material; the curing process includes cooling down and thus solidification of the casing material.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic diagram representing one exemplary embodiment of the method and

FIG. 2 is a cross section along the line II-II in FIG. 1.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

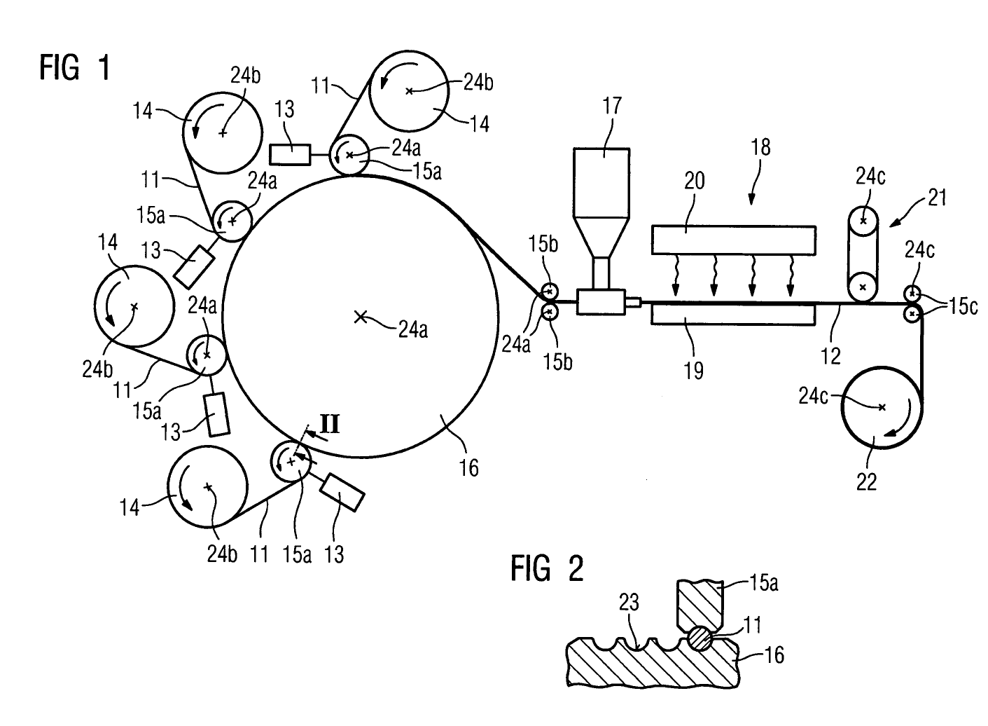

In a production installation as shown in FIG. 1, four individual fibers 11 are joined together to form a fiber strip 12 (which, for example, can be used as a pedestrian sensor in the bumper bar of a motor vehicle), once these have been subjected to a surface treatment process in places by lasers 13. For this purpose, the individual fibers 11 are unwound from supply reels 14 and in each case run together via deflection rollers 15a on a collecting roll 16 with a relatively large circumference, on which they are guided parallel, corresponding to their position in the fiber strip 12 to be produced. Guidance on the deflection rollers 15a at the same time allows surface treatment by the laser 13, since the deflection rollers 15a form a substrate on which the individual fibers 11 can be passed by the laser 13 with high precision.

The four individual fibers are unwound jointly from the collecting roll 16 and are supplied, running parallel, via further deflection rollers 15b to an extrusion device 17, in which they are extrusion-coated with a casing material. The fiber strip 12 produced in this way is then supplied to a curing section 18, which has a linear guide 19 for the fiber strip 12 to be cured, and a light source 20 for the electromagnetic radiation (UV light) required for curing. The cured and therefore complete fiber strip is supplied via a strip buffer 21 to further deflection rollers 15c, and is wound up via them onto a cable drum 22. The fiber strip can be passed on for further processing with the aid of the cable drum. For example, the fiber strip can be cut into sections of suitable length, or can be connected as a sensor strip to an evaluation unit (not illustrated) having light-emitting diodes and photodiodes.

FIG. 2 shows a section through the collecting roll 16 and one of the deflection rollers 15a, with these rollers being profiled on the circumference such that the individual fiber 11 rests on the profiles 23 over a large portion of its circumference. The profiles can be provided in a manner which is not illustrated with a rubber layer, in order to additionally make it harder for the strips to slide.

The rotation axes 24a of the guide rollers 15a and of the collecting roll 16, as well as the rotation axes 25b of the supply reels 14, are all parallel to one another, that is to say at a right angle to the plane of the drawing illustrated in FIG. 1. This additionally assists the process of guiding the individual fibers 11 without twisting them. The rotation axes 24c of the further rollers and reels 15c, 21 and 22 are also at right angles to the plane of the drawing, so that the fiber strip 12 that is being produced can also be wound up largely without any torsion.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide V. DIRECTV, 358 F3d 870, 69 USPQ2d 1865 (Fed. Cir. 2004).

1-10. (canceled)

11. A method for producing an optical fiber strip having a plurality of parallel-running individual optical fibers, comprising:
treating a surface of the individual fibers in places to increase bending dependency of optical attenuation in treated sections;
joining together the individual fibers, subsequent to said treating, to produce the optical fiber strip; and
continuously guiding the individual fibers without torsion at least between said treating of the surface and said joining.

12. The method as claimed in claim 11, further comprising deflecting the individual fibers during the torsion-free guidance by bending the individual fibers.

13. The method as claimed in claim 12, wherein said deflecting includes bending the individual fibers by deflection rollers over which the individual fibers are passed.

14. The method as claimed in claim 13, wherein at least some of the deflection rollers are profiled on circumference, such that a contact area thereof for the guided individual fibers is enlarged.

15. The method as claimed in claim 14, wherein the deflection rollers have deflection rotation axes aligned at least essentially parallel to one another.

16. The method as claimed in claim 15, further comprising prior to said treating:
unwinding the individual fibers from supply reels; and
supplying the individual fibers for said treating.

17. The method as claimed in claim 16, wherein the supply reels have supply rotation axes at least essentially parallel to the deflection rotation axes of the deflection rollers.

18. The method as claimed in claim 17, further comprising winding up the fiber strip onto a cable drum after said joining.

19. The method as claimed in claim 17, further comprising after said joining, extrusion coating the individual fibers with a casing material.

20. The method as claimed in claim 19,
further comprising curing of the casing material subsequent to said extrusion coating, and
wherein said guiding of the individual fibers without torsion is performed during said extrusion coating and said curing of the casing material.
